(19) United States
(12) Patent Application Publication
(10) Pub. No.: US 2006/0121416 A1
(43) Pub. Date: Jun. 8, 2006

(54) Multiple use impression coping

(75) Inventor: Fredrik Engman, Molynlycke (SE)

Correspondence Address: MYERS BIGEL SIBLEY & SAJOVEC, PO BOX 37428, RALEIGH, NC, 27627, US

(73) Assignee: Neoss Limited, Leeds (GB)

(21) Appl. No.: 10/533,480

(22) PCT Filed: Oct. 20, 2003
(86) PCT No.: PCT/GB03/04521

§ 371 Date: Oct. 24, 2005

(30) Foreign Application Priority Data
Oct. 29, 2002 (GB) 0225065.2

(51) Int. Cl. A61C 8/00

(52) U.S. Cl. 433/173

(57) ABSTRACT

A dental impression coping which includes a set of components including an attachment screw access means through the impression material and not more than one attachment screw, that may be used for both pick-up type (open tray) or transfer tray (closed tray) impression moulding techniques. The impression components include an impression coping having non-rotational features and height specific retention means having an outer surface with its bottom end configured to reside preferably below the gingiva surrounding the implant. Means exist on the impression coping, to attach the impression coping to the implant for use in a transfer type impression application. By providing a means to access the attachment screw through the impression material a second impression application, the pick-up type impression application, can be performed, using the same screw that can be used also for the first impression application the transfer type impression application.

### FIELD OF THE INVENTION

This invention relates to the dental implant industry. More specifically, this invention relates to impression copings for use as either a pick-up type or transfer type impression coping by the use of one and the same impression coping including the same screw.

### BACKGROUND OF THE INVENTION

For an artificial tooth (i.e. “dental restoration”) to closely replicate the lost natural tooth that it replaces, the artificial tooth must emerge from the gum tissue with a similar shape and contour, as did the natural tooth. Currently, dental implants, which function as artificial tooth roots and anchors for prostheses, are embedded in the bone tissue of the maxilla and mandible. It is important that the gingiva and soft tissue forms a good contour with the overlying bone where the implant is installed. Prior to the application of functional loads to the implant, healing components generally function to expand a transmucosal opening from the head of the implant fixture to a size that more nearly approximates the size, contour and profile of the tooth where it emerges from the gum. After the healing components have encouraged healing of the gingival tissue, an impression component is used to make a model of the patient's mouth in the area of the implant site. Today an impression taken directly of the head of the fixture and surrounding tissue is frequently performed, especially in cases where early or immediate loading is possible. In such cases healing might not have started at the time of impression taking and the transmuscosal opening has not yet been expanded or contoured.

Creating an artificial tooth or teeth for a patient who has been fitted with one or more dental implants begins with taking this impression of the patient's case. Dental implants have locking means (externally or internally) useful to interlock with corresponding locking means in the components fitted to them when it is desired to prevent rotation of a component relative to the implant around the longitudinal axis of the implant. An implant also has a machined interface to match a corresponding surface on the abutment or other components. This results in a tight seal preventing ingress of bacteria and ensures correct spatial orientation and alignment for a prosthesis. Once the implant has become osseointegrated or achieves stable anchorage with the host bone, it becomes necessary to preserve in the impression the information describing the orientation of its non-rotational connection and machined interface. Recording the correct orientation is critical if an accurate model of the patient's case is to be created in the dental laboratory. The component used to affect this information transfer is commonly called an “impression coping”.

By its very nature the impression material is resilient and elastic enough such that it can be removed from the patient's mouth after it has set, and yet is of sufficient accuracy and stability such that it can preserve geometric detail imparted to it by an impression coping. If the coping used is a transfer type impression coping, it will remain in the patient's mouth when the impression material is removed, pulling the transfer coping out of the socket formed around it in the impression. This technique is known in the art as the “closed tray method” and requires the implant analogue or fixture replica to be mounted on the impression coping which is subsequently reinserted into the same socket before making the master cast. If the coping used is a pick-up type impression coping, it will remain within the impression when the material is removed from the patient's mouth. This technique is known in the art as the “open tray method” and requires that the implant analogue is mounted on the impression coping, while the coping is still being positioned in the impression material, before making the master cast.

A problem that exists with current impression components is that the same components used for pick-up type impression coping cannot be used for transfer type impression coping and vice versa This forces manufacturers to produce two separate lines of impression coping components—one for pick-up type and one for transfer type. Moreover, clinicians are forced to maintain separate inventories of components to be used with either method. In addition several manufacturers have a set of 3 or more different screws heights where there is restricted access to the impression coping screw possibly because of a limitation in mouth opening for low-seated implants in order to get access to the impression coping screw.

U.S. Pat. No. 6,290,499 has tried to solve this but still there exists two screws for either the pick-up type or transfer type impression coping methods and little chance to solve the impression of a low seated implant or restricted access.

Another nuisance for the clinician and the dental technician is that when performing the transfer type impression coping method there is a need to plug and remove the plug from the tool hole in the screw shaft and it is difficult to avoid bad seating from a tap formed by the impression material in this hole.

A snap-on coping for the transfer type technique is proposed by Nobel Biocare International Patent application No. WO 01/64127, but this will only eliminate the screwing and unscrewing, not the need of different copings for different applications. In addition a snap on coping may not provide the accuracy necessary and provided by two mating machined surfaces screwed together.

Therefore, it is an object of the present invention to provide an impression coping system which may be interchangeably used with either pick-up type or transfer type impression coping methods independent of the depth of the placed implant and restricted access and that eliminates bad seating and the use of multiple products to attach the impression coping to the implant and the implant analogue.

It is a further object of the present invention to provide a method of impression coping and a method of dental restoration related thereto which comprises the use of an impression coping as hereinbefore described.

### SUMMARY OF THE INVENTION

The impression components of the present invention include the improved feature of only requiring one single sized coping screw which is used to attach the coping component to the implant. By achieving access through the impression material to the coping screw by a mounted extender or through a superstructure on the coping screw or on the impression coping the coping component may be used as a pick-up type impression coping. However, the same or an identical coping component and coping screw may be used as a transfer type impression coping if no extender or superstructure is used. Therefore, the present invention allows one single coping and one single coping screw to be used for either pick-up type or transfer type impression coping by achieving access to the coping screw through the impression material.

Thus according to a first aspect of the invention we provide an impression coping system comprising an implant fastener or attachment means adapted to engage with an implant and a coping component which engages with the implant fastener and is adapted to support an impression material characterised in that the implant fastener and coping component are adapted to be used for pick-up type (open tray) impression moulding techniques and/or transfer type (closed tray) impression moulding techniques.

A variety of implant fasteners may be used, but preferably the implant fastener is a coping screw which is adapted to engage with an implant.

This invention is described as a set of dental impression components that may be used for both pick-up type (open tray) or transfer type (closed tray) impression moulding techniques. The components are used with an impression material to fabricate an impression at a site in a jawbone where an implant has been placed or reached a state of osseointegration. The impression components include an impression coping having an outer surface with its bottom end generally configured to reside below the gingiva surrounding the implant and one single sized coping screw which is used to attach the coping component to the implant for use in a transfer type impression application. By achieving access to the coping screw through an additional component, an identical coping component and an identical coping screw may be used as a pick-up type impression coping. This additional component can in some configurations be adjusted in height circumferential dimension by the clinician to compensate for implant depth and restricted access providing even more flexibility.

According to a further aspect of the invention we provide an impression coping system as hereinbefore described characterised in that the implant fastener is adapted for use in pick-up type (open tray) impression moulding techniques and is provided with a mountable and removable extension means which, in use, is sufficiently dimensioned so as to act as an extension of the implant fastener and protrude through the impression material (and typically the supporting impression tray).

According to a yet further aspect of the invention we provide an impression coping system according to claim 1 characterised in that the implant fastener is adapted for use in transfer type (closed tray) impression moulding techniques and is provided with an attachment which is adapted to space the implant fastener from the implant.

The invention also includes a coping screw spacer or spacer which preferably is mounted beneath the screw shaft during impression taking and then removed prior to re-seating in the set impression material in order to avoid bad seating due to a tap formed by the impression material in the tool hole in the screw shaft when performing the transfer type impression coping method.

It is a further object of the invention to provide a method of impression coping which utilise the systems hereinbefore described.

Thus, according to this aspect of the invention we provide a method of making an open tray dental impression which comprises the steps of;

(i) placing a coping component on the implant fastener, the fastener optionally being equipped with a spacer;

(ii) engaging the fastener and coping component with an implant;

(iii) if the extender or superstructure is not already pre-mounted by manufacturer, placing an extender component or superstructure component on the fastener and/or coping component or any other suitable function, and optionally adjusting the height of the extender component or superstructure component;

(iv) moulding an impression material around the coping component and the extender;

(v) disengaging the coping component from the implant by unscrewing the screw:

(vi) removing the impression moulded material (which at this point will carry the coping component, fastener and extender or superstructure);

(vii) fitting the implant analogue to the coping component and the screw; and

(viii) fabricating a master cast from the impression moulding containing the implant analogue positioned on the coping component and completing the transfer of the implant position from the oral cavity to a model of the oral cavity.

According to an alternative aspect of the invention we provide a method of making a closed tray dental impression which comprises the steps of;

(i) placing a coping component on an implant fastener;

(ii) engaging the fastener, which is fitted with a spacer element, with an implant;

(iii) moulding an impression material around the coping component;

(iv) removing the impression moulded material;

(v) removing the spacer element from the fastener and fitting the fastener and coping component to the implant analogue; prior to refitting the coping component engaged with the implant analogue, preferably by the retention of the fastener, into the socket of the impression material, by pushing the coping component and turning it to the correct position determined by positioning means on the coping; and

(vi) fabricating a master cast from the impression moulding containing the implant analogue positioned on the coping component and completing the transfer of the implant position from the oral cavity to a model of the oral cavity.

It will be well understood by those skilled in the art that the steps described above need not be taken sequentially, rather the steps are merely illustrative of the process. Therefore the methods as hereinbefore described should not be considered to be limited in such a manner.

The extension component as hereinbefore described is novel per se. Thus according to a yet further aspect of the invention we provide an extension component for use in a system as hereinbefore described. A variety of such extension components may be used, however, preferably the extension components may comprise a tubular sleeve, e.g. comprising a plastic material. The extension component may be adapted to fit on the coping component or, alternatively, on the implant fastener, but preferably the extension component will form a snug fit around the outer surface of the implant fastener

Similarly, the spacer component as hereinbefore described is novel per se. Thus, according to another aspect of the invention we provide an implant fastener spacer component. The spacer preferentially comprises an annular ring, and especially a split annular ring. It is found to be especially advantageous for the spacer to be a split annular ring since such a spacer may readily be removed as desired by the clinician using a conventional dental implement or by the dental technician.

It is a further novel aspect of the invention to provide the use of an extension component in a system or method as hereinbefore described.

It is also a novel aspect of the invention to provide the use of a spacer in a system or a method as hereinbefore described.

In another aspect of the invention we provide a kit suitable for pick-up type (open tray) impression moulding comprising at least an implant fastener, a coping component and a extension member.

Alternatively we provide a kit suitable for transfer type (closed tray) impression moulding comprising at least an implant fastener, a coping component and a spacer.

In relation to the aforementioned kits, it will be understood that a kit may be provided which is suitable for both pick-up type and transfer type impression moulding.

Additional objects and features of the invention will be apparent in the following description of exemplary embodiments of the invention with reference to the accompanying drawings. The scope of the invention is delineated in the claims that are appended to this application.

### BRIEF DESCRIPTION OF THE DRAWINGS

In the accompanying drawings:

FIG. 1 is a general view of a placed dental implant;

FIG. 2A is a side view of an impression coping representing an internal implant abutment connection in the prior art;

FIG. 2B is a longitudinal section through FIG. 2A;

FIG. 2E is a top view of FIG. 2A;

FIG. 2F is a bottom view of FIG. 2A;

FIG. 2C is a side view of an impression coping representing an external connection in the prior art;

FIG. 2D is a longitudinal section through FIG. 2C;

FIG. 3A is a pick-up impression coping screw described in the prior art;

FIG. 3B is a pick-up impression coping arrangement described in the prior art assembled on a dental implant;

FIG. 4A is a transfer impression coping screw described in the prior art;

FIG. 4B is a transfer impression coping arrangement described in the prior art;

FIG. 4C is a pick-up impression coping arrangement described in the prior art assembled on an implant analogue;

FIG. 5A is a side view of an impression coping according to the invention;

FIG. 5B is a longitudinal section through FIG. 5A;

FIG. 5C is a top view of FIG. 5A;

FIG. 5D is a bottom view of FIG. 5A;

FIG. 6A is a side view of an impression coping screw according to the invention used for a transfer impression application;

FIG. 6B is a transfer impression coping arrangement with screw according to the invention assembled on a dental implant during impression taking;

FIG. 7A is a side view of an impression coping spacer according to the invention;

FIG. 7B is a side view of an impression coping screw arrangement with screw and spacer according to the invention;

FIG. 7C is a transfer impression coping arrangement with coping, screw and spacer according to the invention during impression taking;

FIG. 7D is a transfer impression coping arrangement with coping, screw and spacer according to the invention during master casting assembled on an implant analogue;

FIG. 8A is an impression coping screw according to the invention;

FIG. 8B is a superstructure for an impression coping screw according to the invention used for a pick-up impression application;

FIG. 8C is a pick-up impression coping arrangement with coping, screw and superstructure according to the invention assembled on a dental implant;

FIG. 8D is an extender for a pick-up impression coping screw according to the invention;

FIG. 8E is a pick-up impression coping arrangement with coping, screw and extender according to the invention assembled on a dental implant;

FIG. 9 are the components according to the invention necessary to perform the impression following either the pick-up or the transfer impression technique;

### DETAILED DESCRIPTION OF THE DRAWINGS

Prior Art Including Method

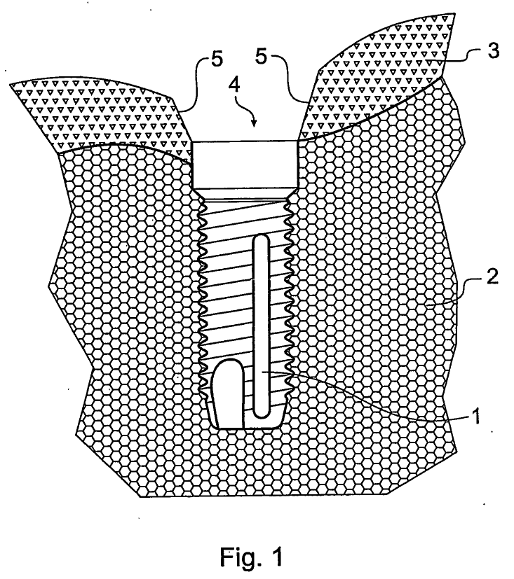

In FIG. 1 is shown an installed dental implant (1) which is fixed in bone (2) having overlying gingiva (3) with an opening (4) giving access to the implant (1). The emergence profile (5) to be given to the opening (4) through the gingiva will depend on the type of tooth to be restored and the position where the implant is installed. A healing abutment prior to the impression taking has preferably contoured the emergence profile of the gingiva (3), but there are situations where an earlier loading or function of the prosthesis is wanted and an impression is taken before the final soft tissue contour is formed.

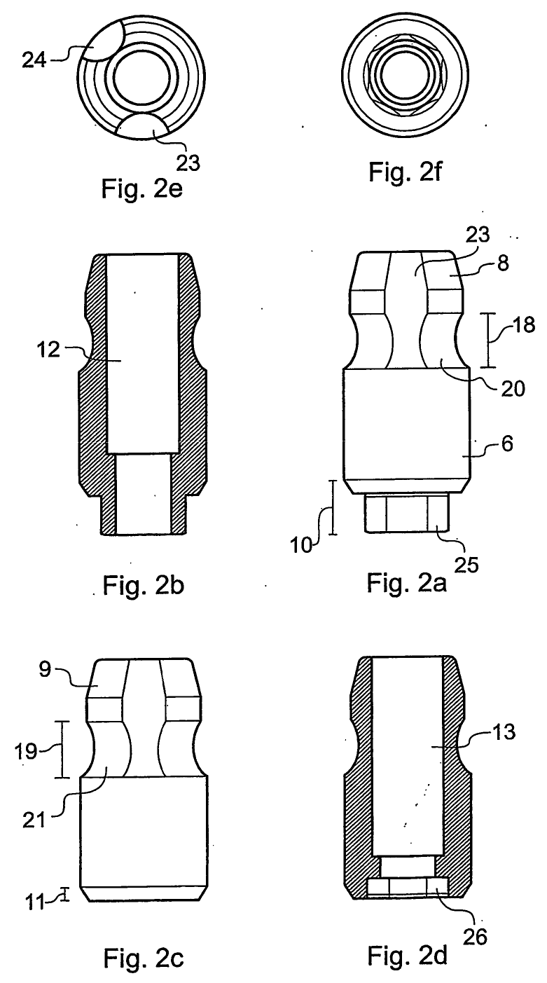

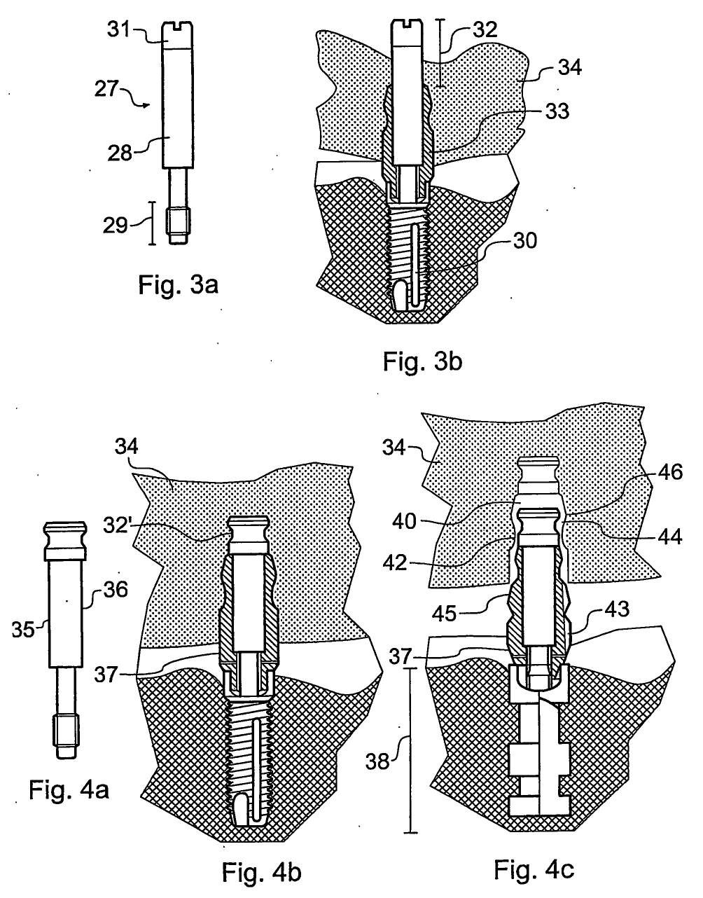

Referring to FIGS. 2A-F, two different impression coping components (6,7) are illustrated together with screws, FIGS. 3A-B, representing the prior art. The coping components have a top end, (8,9), and a bottom end, (10,11) and a through passage (12,13) from one end to the other. FIG. 2E is a view of the top end (8,9). FIG. 2F is a view of the bottom end (10,11). The coping component (6,7) is tubular in form, symmetrical around its longitudinal axis A-A. At least one portion but preferably 2 (18,19) or more of the outer surface of the coping (6,7) is circumferentially recessed (20,21). At least one, but preferably two, or more longitudinal recesses (23, 24) or ridged, are symmetrically arrayed around the upper portion of the coping, extending from the circumferentially recess (21, 22) to the upper end (8, 9). The recesses (23, 24) are formed on a circular locus, but that is by way of example only. Recesses having other transverse-sectional shapes, such as rectangular and triangular, may also be used in copings of the invention. An anti-rotation post (25) or socket (26) of known form, for example polygonal such as hexagonal, octagonal or any anti-rotation means such as ridges, representing an external or internal implant abutment connection, is located in the bottom end (10, 11), preferably symmetrical around the axis A-A. The through passage (12, 13) opens into this anti-rotational socket (26) or extends through this anti-rotational post (25). A snap-on function, not shown, for engaging the impression coping to the implant mainly for the transfer type application can be included the said anti-rotational socket 26 or post 25.

A coping screw 27 (FIG. 3A) has a shaft 28 sized to fit in the through passage (12, 13), a threaded end 29 for engaging in a threaded bore in an implant 30 (FIG. 3B), and a head 31 for manipulating the screw 27, and for other uses to be presently described. As is shown in FIG. 3B, the head 31 abuts the end 8 of the coping component when the latter is fixed to the implant 30, which has an internally or externally mating surface of known form to fit the anti-rotational socket or post of the coping. The coping screw 27 of FIG. 3A is intended to be used in pick-up type impression coping applications. The head 31 of the pick-up type coping screw 27 is extended in length such that the top 32 of the coping screw is positioned substantially above the top of the coping component 33. This arrangement allows the coping screw 27 to be removed from the coping component 33 after an impression has been taken with an impression material 34, thereby allowing the component 33 to remain within the impression material 34 as it is removed from the patient's mouth.

If a transfer type impression application, FIGS. 4A-C, is desired, an additional coping screw 35 of FIG. 4A is used. The screw shaft 36 of this screw 35 is usually not equipped with any means such as slot or a internal hex for the use of a screwdriver. Instead placement and retrievability is made by the use of the fingers since a slot or a hex would interfere during reseating of the coping 37 after the impression taking and prior to the casting of the master model 38.

Referring now to FIGS. 3B and 4B, when the impression material 34 sets up around the coping component 33, 37 and coping screw shaft 32, 32′ an impression socket 40 is formed in the impression material 34 replicating in reverse the shape and size of the coping 33, 37 and the protruding part 32, 32′ of the screw. Thus, for the annular recesses 20, 21 there are an annular bulge 42, for each longitudinal recess 43 there is a longitudinal bulge 44 and for each projection 45 there is a corresponding recess 46.

Whenever the coping is reinserted into the socket 40, each of the projections can occupy any of the corresponding recesses, thus replicating only one possible orientation position of the coping described above with reference to FIG. 2A or 2C. Additional objects and features of the invention will be apparent in the following description of exemplary embodiments of the invention with reference to the accompanying drawings. The scope of the invention is delineated in the claims that are appended to this application.

Systems of the Invention

(Transfer+Pick-Up Common Features)

An impression coping according to the invention is compatible with implants or abutments as by known features of existing implant systems but can also be designed to be used with new implant systems and features of the implant to abutment interface

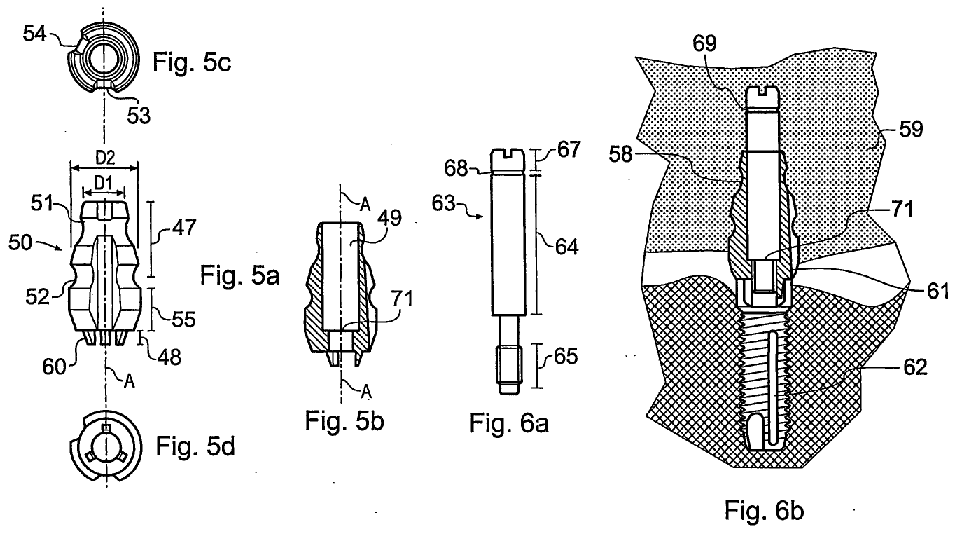

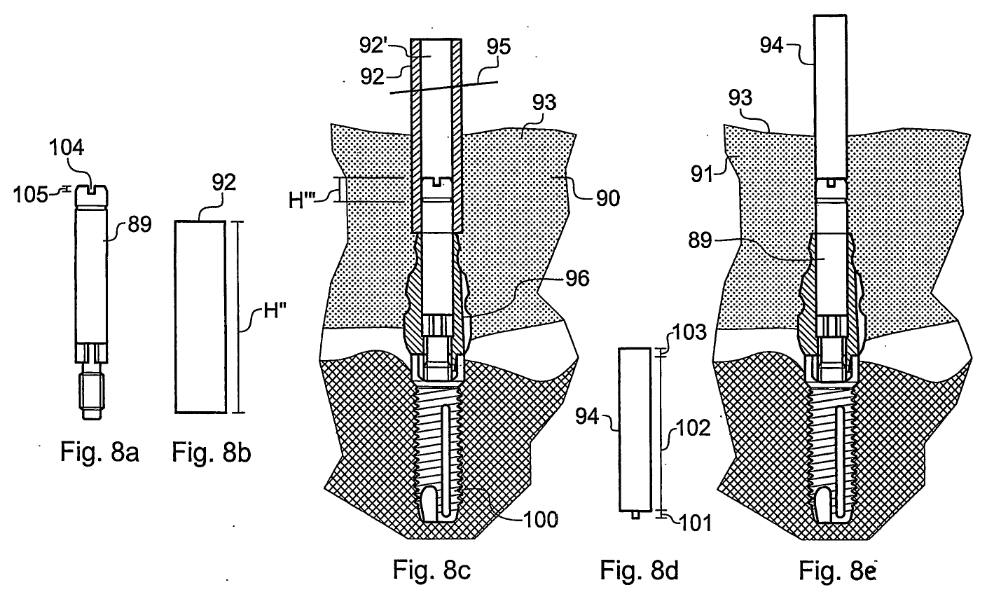

This invention is described as a set of dental impression components, FIG. 5-10, that may be used for both pick-up type (open tray), FIG. 8A-D, or transfer type (closed tray), FIG. 7A-D, impression moulding techniques. The components are used with an impression material to fabricate a model at a site in a jawbone where an implant has been placed or reached a state of osseointegration, FIG. 1, as described in the prior art.

The impression components of the present invention include the improved feature of only requiring one single sized coping screw which is used to attach the coping component to the implant. The coping design can be of a design proposed in FIG. 5A-D, or represented by the prior art, FIG. 2-4.

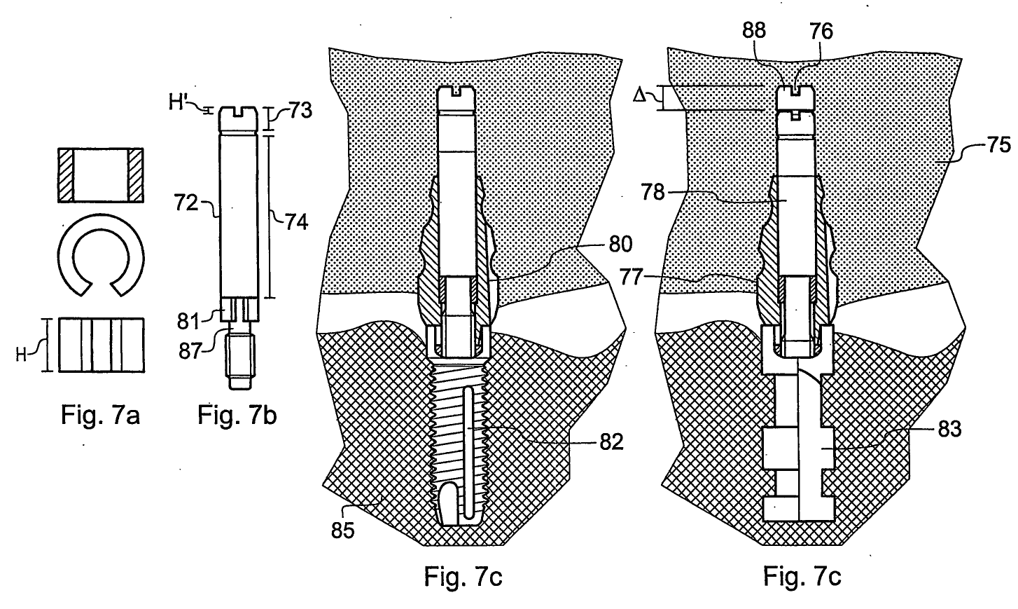

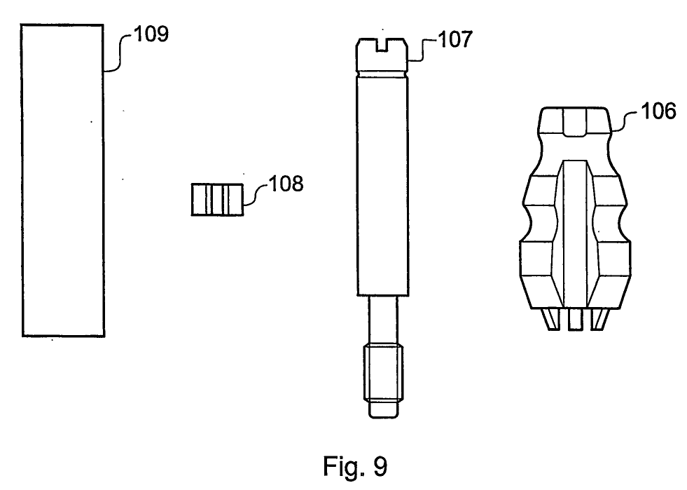

The coping component 50 has a top end 47 and a bottom end 48, and a through passage 49 from one end to the other. FIG. 5C is a view of the top end. FIG. 5D is a view of the bottom end. The coping component 50 is tubular in form, symmetrical around its longitudinal axis A-A. At least one, preferably two (51, 52) or more portions, of the outer surface of the coping 50 is circumferentially recessed. At least one preferably two, or more, longitudinal recesses 53, 54 are symmetrically arrayed around the upper portion of the coping, extending from the gingival portion 55 to the upper end 47. The recess geometry of 51-54 is by way of example only. The head 57 has a diameter D1, which is smaller than the diameter D2 of the coping component 50. This combination, FIGS. 6A-B, forms a socket 58 in the impression material 59, which is narrower at its interior end that it is at its open end to facilitate for re-insertion during the so called transfer impression technique previously described. During reinsertion of the coping 45 into the impression socket 58 the head 47 can “feel” the entrance to the narrow end and guide the coping into the socket while the impression interlocking elements 53, 54 are being manipulated around the axis A-A. An anti-rotation means, for example according to the prior art previously mentioned but here represented by an internal abutment connection means 60, FIG. 5A, is located in the bottom end 48, symmetrical around the axis A-A. The through passage 49 opens into this anti-rotational means 60. The coping can also be prepared, FIG. 9, to hold a superstructure described later.

The coping 61 is attached, FIG. 6A-B, to the implant in known fashion using a single screw 63 or for some applications, like the transfer type application, an additional clamping type of fastening (not shown) can alternatively be used. The core component 61 is thereby fixed non-rotatably on the implant 62 and the same coping can be used for the pick-up type (open tray) or transfer type (closed tray) impression technique. A coping screw 63 has a shaft 64 sized to fit in the through passage 49, a threaded end 64 for engaging in a threaded bore 66 in an implant 62, and a head 67 for manipulating the screw with a tool (not shown), and for other uses to be presently described. The head 67 may take many forms. It may include a circumferential recess 68 as shown, for additional retention in the impression socket 58. It may omit any such recess. It may be shorter or longer than the head that is illustrated, FIG. 6A-B, but preferably extending outside the coping 61 when it is in its screwed in position, FIG. 6B. It has means 70 to engage a driver or similar tool, not shown, for turning it. Self-guiding properties like conical form of the screw seating surface can be incorporated in order to be optimised for the transfer type application accuracy.

The impression taking arrangements, transfer and pick-up type, including the additional components modifying the screw and/or the screw according to the invention to make this dual use coping possible will hereforth be described by first looking at the transfer application.

(Transfer)

Unlike the prior art, FIGS. 3 and 4, for the transfer type application, the screw 63 according to the invention, as described in FIGS. 7A-D, is equipped with a head 67 for manipulating the screw with a driver or a tool, this head being preferably of similar diameter as the shaft 64. Still the placement and retrievability may be made by the use of the fingers. According to FIG. 7A-D, the re-seating difficulties of the impression coping arrangement (impression coping 77, impression coping screw 78 and spacer 86) in to the impression material 75 after impression taking due to the formation of an impression material portion 76 formed in the means 79 to engage a driver for turning using such a screw 72, 78 can be avoided by lowering the engagement portion 73 of the screw 78 the distance A relative to the impression coping 77 prior to the casting of the master model. The lowering is preferably performed by the removal of spacer or shims 80 under the screw shaft 74. The spacer 81 is preferably introduced or positioned, FIG. 7B, under the screw shaft before delivery to the end user and remains in place during impression taking, FIG. 7C. Prior to mounting and fastening the implant analogue on the impression coping by the screw 78, the spacer 80 is removed from the screw 78, for example peeled of with a pair of twisters or a scalpel, and thereby creating a void 88 when reinserted into the impression material. After this the conventional casting of the master model, FIG. 7D, can take place,

The invention, FIG. 7A-D, also includes the method of using a coping screw spacer 80, 81 which preferably is mounted, FIG. 7B, beneath the screw shaft during impression taking, FIG. 7C, on the implant 82 in the bone 85 and then the spacer 80 is removed prior to re-seating, FIG. 7D, in the cured impression material 75 and mounting on an fixture replica, implant replica or implant analogue, in order to avoid bad seating due to a tap 76 formed by the impression material in the tool hole 79 of the screw 72, 78 when performing the transfer type impression coping method and forming the master cast 84 creating a void or a space 88 in the impression material where the screw engagement portion 73 was before the spacer 80 was removed.

The spacer can be in the form of an open ring 86, tube or cylinder placed around the screw neck 87 under the screw shaft 74, the height H preferably of larger height H′ than the inner tool connection of the attachment means 72, 78, said spacer being removed prior to reinsertion of the impression coping 77 in the impression material 75.

In addition or independently the spacer 86 can function as a retention element between the inner recess or through passage 49 of impression coping and the screw 72, 78, thus avoiding the screw from falling out from the impression coping during carrying, placement or disengagement of the impression coping assembly. The material of the spacer is preferably a plastic material. In one embodiment the spacer is made in an elastic material which as a result of the lower torque during attaching it to the implant 82 compared to the higher torque attaching it to the implant analogue 83 by compressing the spacer 80, is creating the space 88 and thus making it unnecessary to remove the spacer 80.

(Pick-Up)

According to the invention, in complement to the transfer type application the same coping and coping screw can be used to perform the pick-up type application using the additional components, arrangement and method described in the following; using the identical coping component 96 and an identical coping screw 89 as previously described for the transfer type application, FIGS. 7A-D, the pick-up type application, FIGS. 8A-E, can be performed by achieving access and subsequent screwing and unscrewing possibility to the coping screw 89 through the impression 90, 91 material by an additional component. This additional component can be a superstructure 92, FIG. 8B-C, forming a substantially straight channel 92′ from the screw 89 past the upper surface 93 of the impression material 90 for the access of a screwdriver (not shown) to the screw 89, or an extender 94, FIG. 8D-E. This additional component can in some configurations be adjusted 95 in height H″ by the clinician providing even more flexibility.

The superstructure 92 is preferably in the form of a tube that preferably is mounted by the user on upper portion 105 of the screw shaft protruding the height H′″ above the impression coping 96 prior to the impression taking, FIG. 8C. Another preferred embodiment (not shown) is when a superstructure 92 instead is being placed mainly in contact with the coping 96. In general the tubular passage 92 is being made in plastic.

The method characterising the use of the superstructure 92 is that the coping 96 is positioned on the implant 100 and secured thereon by the means of a screw or attachment 89 through an internal channel 92′. The tube 92 is thereafter placed on the screw part 105 protruding above H′″ the coping 96 and then the impression taking can take place according to well-known practice. After the impression material has set the screw is loosened by introducing a screwdriver device through said channel and subsequently turned. The impression material 90 with coping 96, screw 89 and tube 92 is lifted off from the implant 100. An implant analogue, the same 83 type as for the transfer type application, is secured (not shown) on the coping 96 by means of the screw 89 though the channel 92′ and then a master cast or model is made according to general methods known by the dental profession.

The optional embodiment of an extender 94, FIG. 8D-E, instead of a superstructure 92 features a tool end 101, a shaft 102 penetrating the impression material 91 and an upper portion 103. The upper portion 103 can feature a tool hole which can be the same as the tool hole 104 in the screw shaft or it can be designed for being rotated by the use of fingers or a combination of both in order to transmit torque force for unscrewing and screwing of the screw 89 during the impression taking procedure or method including the making of the master cast and the mounting of an implant analogue or replica on the impression coping previously described.

Therefore, as summarised in FIG. 9, the design of this impression coping arrangement further provides the advantage of enabling the use of a single coping component 106 for either transfer impression coping or pick-up impression coping applications. The coping 106 is designed to accept one single coping screw 107 with the screw in the preferred embodiment designed to accept a spacer 108 and superstructure in the form of a tube 109. Since a single coping component may be used for either impression coping method, a clinician is now able to easily select the most appropriate impression coping method for a given case. This choice can even be made during practice, for example during surgery. A clinician need only to mount or remove the extender or superstructure used with the coping component in order to change techniques depending on if they where pre-mounted or not. Moreover, this new design feature requires only one coping component to be manufactured and inventoried contrary to the manufacture and inventory of two separate coping screw components in the past (one for pick-up type applications and one for transfer type applications (including a number of screw types and lengths). Therefore, this invention provides for a more modular design that is more economical for clinicians and manufacturers since only one type of coping component needs to be manufactured, purchased, and inventoried.

The impression coping arrangement may take a somewhat conical or pyramidal form, which has an advantage when taking an impression of a case having two copings on divergent axes. In such a case, if the two copings are cylindrical they will have remote surfaces that diverge, making it difficult to remove the copings from an impression. The conical form made possible in the present invention prevents divergence of the remote surfaces over a wide range of divergent axes.

Accordingly, in the claims that follow, the term “coping” is intended to encompass any structure or combination of structures that forms the impression socket 58.

The present invention thus presents a new and inventive step to perform a transfer or pick-up type of impression technique using a single coping, a single screw, an access means and a spacer. At the time of this invention, the description above provides the optimal configuration of the coping component, which employs a superstructure or extender in co-operation with the customary pick-up or transfer impression procedure. However, it is to be understood that other embodiments are possible, and are intended to be embraced within the scope of the appended claims.

While the present invention has been described with reference to one or more preferred embodiments, those skilled in the art will recognise that many changes may be made thereto without departing from the spirit and scope of the present invention which is set forth in the following claims.

### REFERENCES

DIA™. Dental Imaging Associates, Inplamed—The Source, The Anatomical Abutment System, Copyright Date Oct. 9, 1991 on p. 10 (front cover, pp. 1-10, and back cover).
Lewis et al., Single Tooth Implant Supported Restorations, International. Journal. of Oral & Maxillofacial Implants, vol. 3, No. 1, pp. 25-30, 1988.
Lewis et al., The “UCLA” Abutment, International. Journal. of Oral & Maxillofacial Implants, vol. 3, No. 3, pp. 183-189, 1988.
Prosthetic Catalog, 1993, Implant Innovations, Inc. (3 pages).
Prosthetic Catalog, Impression Copings, Implant Innovations, Inc. (3 pages).
Zarb, George A. and Thomas Jansson, Tissue-Integrated Prostheses, Osseointegration in Clinical Dentistry, Chapter 17, Laboratory Procedures and Protocol, pp. 293-315, 1985.
Technical information and product catalogue, 2000, Advent and Screw-Vent implant system, Paragon implant company.

1. An impression coping system comprising an implant fastener or attachment means adapted to engage with an implant and a coping component which engages with the implant fastener and is adapted to support an impression material characterised in that the implant fastener and coping component are adapted to be used for pick-up type (open tray) impression moulding techniques and/or transfer type (closed tray) impression moulding techniques.

2. An impression coping system according to claim 1 characterised in that the implant faster is provided at an implant engaging end with a screw thread.

3. An impression coping system according to claim 2 characterised in that the implant faster is a coping screw.

4. An impression coping system according to claim 1 characterised in that the implant fastener is adapted for use in pick-up type (open tray) impression moulding techniques and is provided with a mountable and removable extension means which, in use, is sufficiently dimensioned so as to act as an extension of the implant fastener and protrude through the impression material.

5. An impression coping system according to claim 4 characterised in that the extension means is adapted to form a snug fit on the external surface of the body of the fastener.

6. An impression coping system according to claim 5 characterised in that the extension means comprises a tubular sleeve.

7. An impression coping system according to claim 6 characterised in that the tubular sleeve is profiled.

8. An impression coping system according to claim 6 characterised in that the tubular sleeve is adapted to be cut to an appropriate length.

9. An impression coping system according to claim 6 characterised in that the tubular sleeve comprises a plastics sleeve.

10. An impression coping system according to claim 4 characterised in that the extension means is adapted to stay in the impression material after impression.

11. An impression coping system according to claim 4 characterised in that the tubular passage is adapted to stay on the implant fastener and thereby is removed from the impression material after impression.

12. An impression coping system according to claim 4 characterised in that the extension member is placed mainly in the contact coping by the manufacturer.

13. An impression coping system according to claim 1 characterised in that the implant fastener is adapted for use in transfer type (closed tray) impression moulding techniques and is provided with an attachment which is adapted to space the implant fastener from the implant.

14. An impression coping system according to claim 13 characterised in that the implant faster is provided with a fastening region

15. An impression coping system according to claim 14 characterised in that the fastening region is of narrower diameter than the body of the fastener.

16. An impression coping system according to claim 14 characterised in that the fastening region an implant engaging end with a screw thread.

17. An impression coping system according to claim 15 characterised in that the fastening region is provided with a shoulder.

18. An impression coping system according to claim 13 characterised in that the spacer is adapted to be removed by a conventional dentistry implement or finger

19. An impression coping system according to claim 13 characterised in that the spacer is an annular ring.

20. An impression coping system according to claim 19 characterised in that the spacer comprises an annular split ring.

21. An impression coping system according to claim 1 characterised in that the coping component comprises an annular sleeve.

22. An impression coping system according to claim 21 characterised in that the annular coping sleeve comprises a slidable sleeve

23. An impression coping system according to claim 22 characterised in that the annular coping sleeve is rotatably slidable.

24. An impression coping system according to claim 1 characterised in that the coping sleeve adapted to be supported by a surface of the implant.

25. An impression coping system according to claim 1 characterised in that the implant is provided with a shoulder for supporting coping sleeve.

26. An impression coping system according to claim 21 characterised in that the diameter of coping sleeve is substantially the same as the diameter of the implant.

27. An impression coping system according to claim 13 characterised in that the spacer is placed mainly in contact with the fastening region by the manufacturer.

28. A method of making an open tray dental impression which comprises the steps of;
(i) placing a coping component on the implant fastener, the fastener optionally being equipped with a spacer;
(ii) engaging the fastener and coping component with an implant;
(iii) if the extender or superstructure is not already pre-mounted by manufacturer, placing an extender component or superstructure component on the fastener and/or coping component or any other suitable function, and optionally adjusting the height of the extender component or superstructure component;
(iv) moulding an impression material around the coping component and the extender;
(v) disengaging the coping component from the implant by unscrewing the screw:
(vi) removing the impression moulded material (which at this point will carry the coping component, fastener and extender or superstructure);
(vii) fitting the implant analogue to the coping component and the screw; and
(viii) fabricating a master cast from the impression moulding containing the implant analogue positioned on the coping component and completing the transfer of the implant position from the oral cavity to a model of the oral cavity.

29. A method of making a closed tray dental impression which comprises the steps of;
(i) placing a coping component on an implant fastener;
(ii) engaging the fastener, which is fitted with a spacer element, with an implant;
(iii) moulding an impression material around the coping component;
(iv) removing the impression moulded material;
(v) removing the spacer element from the fastener and fitting the fastener and coping component to the implant analogue; prior to refitting the coping component engaged with the implant analogue, preferably by the retention of the fastener, into the socket of the impression material, by pushing the coping component and turning it to the correct position determined by positioning means on the coping component; and
(vi) fabricating a master cast from the impression moulding containing the implant analogue positioned on the coping component and completing the transfer of the implant position from the oral cavity to a model of the oral cavity.

30. An impression coping according to claim 13 wherein a means of the impression coping screw is only removed for the transfer type (closed tray) impression moulding techniques to decrease the height of the screw shaft after impression taking and prior to reinsertion of the impression coping in the impression material for the making of a master cast for the transfer type application, and thereby increasing the accuracy of the transfer type impression application
said means being a spacer in the form of an open or closed ring, tube or cylinder placed around the screw neck under the screw shaft, the height preferably of larger height than the inner tool connection of the attachment means, said spacer being removed prior to reinsertion of the impression coping in the impression material.

32. An impression coping according to claim 13 wherein a means of the impression coping screw is removed to decrease the height of the screw shaft after impression taking and prior to reinsertion of the impression coping in the impression material for the making of a master cast for the transfer type application, and thereby increasing the accuracy of the transfer type impression application
said means being a spacer in the form of an open or closed ring, tube or cylinder placed around the screw neck under the screw shaft, the height preferably of larger height than the inner tool connection of the attachment means, said spacer being exhibiting elastic properties in such way that the height of the spacer depends on torque levels thus being unnecessary to remove, said torque levels being higher for the attachment for the model making on the implant analogue than for the model taking on the implant.

33. A dental impression coping system according to claim 1 for co-operating with an impression material to take an impression for making a model of a region in a mouth adjacent to an aperture in gingiva which exposes an implant that is installed in bone for pick-up type (open tray) and/or transfer type (closed tray) impression moulding techniques, said system comprising:
a non-rotational fitting for mating with a corresponding fitting of said implant;
an outer surface having a transgingival section configured to fit within said aperture and a supragingival section for embedment in said impression material, said supragingival section having at least one part with a non-circular cross-sectional, said impression coping capable of being transferred back into said impression material after said impression is taken preferably if using a transfer type impression mould technique;
a means intended for fastening or clamping said impression coping to said implant,
an inner surface defining a passage that is generally aligned with said implant for receiving an attachment means intended for fastening said impression coping to said implant:
an attachment means intended for fastening said impression coping to said implant providing the said impression coping
a superstructure or extender being able to be mounted in contact with said attachment means or said impression coping providing a means to access the said attachment means through the said impression material also providing the said impression coping to be used with the said pick-up impression application.

34. The impression coping of claim 1 wherein said implant fastener or attachment means for pick-up type (open tray) and/or transfer type (closed tray) coping component relies upon on friction, elastics or mechanical interlocking.

35. The impression coping of claim 1 wherein the outer surface of the coping component is provided with a plurality of recesses.

36. An impression coping according to claim 1 wherein a spacer attached to screw can exhibit the retention of the attachment means being a screw, to the impression coping inner recess avoiding the part to disengage during carrying, placing and removal from the implant or implant analogue.

37. An extension component for use in a system according to claim 4.

38. An extension component according to claim 37 characterised in that the extension component comprises a tubular sleeve.

39. The use of an extension component in a method according to claim 28.

40. The use of an extension component in a system according to claim 4.

41. The use of a spacer in a method according to claim 29.

42. The use of a spacer in a system according to claim 13.

43. A spacer component for use in a system according to claim 1

44. A spacer component according to claim 43 characterised in that the spacer comprises an annular ring.
removing the superstructure or extender prior to model taking if using the transfer type application
applying impression material into said mouth and around said at least one first and second interlocking recesses of said coping, said second recess having a predetermined angular orientation with respect to said impression material after being applied around said coping;
if using said transfer type application removing said impression material from said mouth and then removing the impression coping from the implant by unscrewing the screw by hand or by screw driver followed by mounting the implant analogue on the impression coping after having removed the spacer on the impression coping screw and subsequently reinserting said impression coping into an opening, preferably the same it was earlier removed from, within said impression material:
if using said pick-up application removing said impression coping from the implant by unscrewing the screw through the said access means, superstructure or extender followed by moving said impression material and impression coping arrangement from said mouth and mounting the implant analogue on the impression coping;
the casting of the stone model is then made irregardless of pick-up or transfer type impression technique.

51. A kit suitable for pick-up type (open tray) impression moulding comprising at least an implant fastener, a coping component and an extension member.

52. A kit suitable for transfer type (closed tray) impression moulding comprising at least an implant fastener, a coping component and a spacer.

53. An impression coping system or a method substantially as described with reference to the accompanying examples.
